(19) United States
(12) Patent Application Publication
(10) Pub. No.: US 2001/0054589 A1
(43) Pub. Date: Dec. 27, 2001

(54) SEPARATING DEVICE AND METHOD FOR SEPARATING SOLID PARTICLES FROM A FLUID

(76) Inventors: GLENN ALLAN OSTROWSKI, SALISBURY, MD (US); ROBERT G. SPALDING, SALISBURY, MD (US)

Correspondence Address: JENKENS & GILCHRIST, P.C., 1445 Ross Avenue, Suite 3200, Dallas, TX, 75202-2799, US

(21) Appl. No.: 09/238,237

(22) Filed: Jan. 27, 1999

(51) Int. Cl. B01D 35/02

(52) U.S. Cl. 210/767

(57) ABSTRACT

A separating device for separating particles from fluid in which an inlet passage is defined in the body member of the device for receiving the fluid and an outlet passage extends parallel to the inlet passage for discharging the fluid. A chamber is connected to the inlet passage for receiving the fluid from the inlet passage, and a separator is disposed in the chamber for separating particles from the fluid as the fluid flows through the chamber. A cover is connected to the chamber and the outlet passage for receiving the separated fluid, reversing the direction of the separated fluid and directing the separated fluid to the outlet passage for discharge from the body member. The cover can be a filter unit for providing additional filtering of the fluid.

### BACKGROUND OF THE INVENTION

The present invention relates to a separating device and method and, more particularly, to such a device and method according to which solid particles are separated from a fluid as the fluid flows through a flow line.

Many types of separating devices are available for purifying fluid by separating solid particles from the fluid as it flows though a flow line. However, these devices suffer from one or more problems. For example, in some designs the separated particles are prone to drop back into the inlet pipe for the device especially when the fluid flow is terminated. In other designs, it is difficult to avoid fluid spillage when the filter, or strainer, is accessed for the purpose of cleaning, etc. These problems are especially acute when the device is used in a gasoline dispensing installation in a service station, since it is critically important in this environment that the flows lines not be clogged and spillage of the gasoline be prevented. Also, these prior art devices are often expensive and bulky.

Therefore, what is needed is a separating device and method for a fluid flow system which prevents the separated particles in the strainer from dropping back into the inlet pipe for the device when the fluid flow has been terminated. Also needed is a device and method of the above type in which spillage is avoided when the strainer or filter member of the device is accessed. Further, a device of the above type is needed that is relatively inexpensive and compact.

### SUMMARY OF THE INVENTION

The present invention, accordingly, is directed to a separating device for separating particles from fluid in which an inlet passage is defined in the body member of the device for receiving the fluid and an outlet passage extends parallel to the inlet passage for discharging the fluid. A chamber is connected to the inlet passage for receiving the fluid from the inlet passage, and a separator is disposed in the chamber for separating particles from the fluid as the fluid flows through the chamber. A cover is connected to the chamber and the outlet passage for receiving the separated fluid, reversing the direction of the separated fluid, and directing the separated fluid to the outlet passage for discharge from the body member.

The cover can either be a dome-shaped device or a filter unit for providing additional filtering of the fluid.

Thus, a major advantage is achieved with the device and method of the present invention since the separated particles in the device are prevented from dropping back into the inlet pipe for the device when the fluid flow has been terminated. Also, the device and method of the present invention eliminate spillage of the fluid when the strainer or filter member of the device, yet is relatively inexpensive and compact.

### BRIEF DESCRIPTION OF THE DRAWINGS

FIG. 1 is a sectional view of the separating device of the present invention.

FIG. 2 is a view similar to FIG. 1 but depicting an alternate embodiment of the present invention.

### DESCRIPTION OF THE PREFERRED EMBODIMENTS

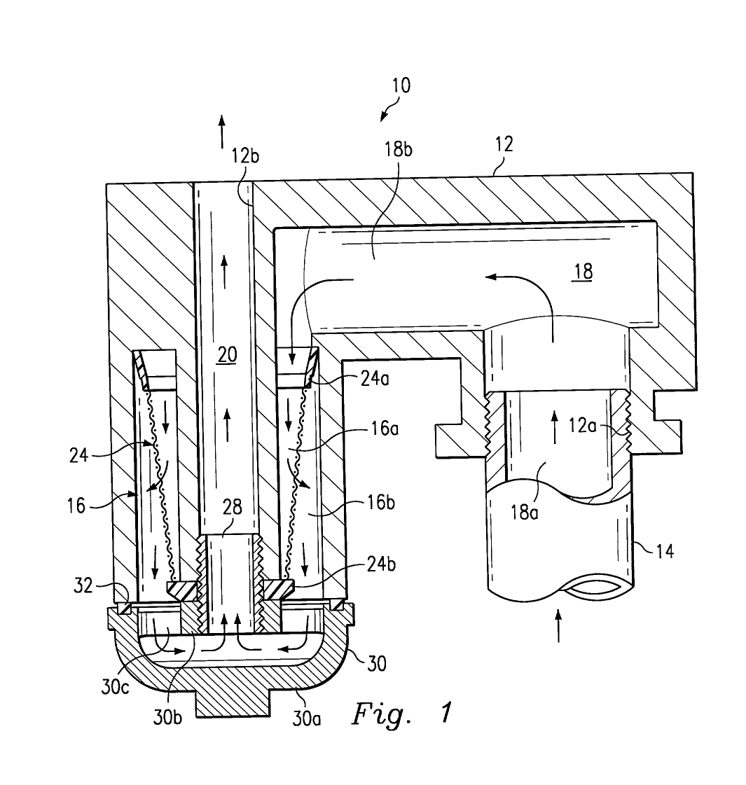

Referring to FIG. 1 of the drawings, the reference numeral 10 refers in general, to the separating device of the present invention which is formed by a body member 12 fabricated of a rigid material such as metal or plastic, and having an inlet opening 12a threadedly connected to an inlet pipe 14. An annular elongated chamber 16 is formed in the body member 12, and an internal inlet passage 18, having a vertical leg portion 18a and a horizontal leg portion 18b, extends through the body member from the inlet opening 12a to the upper portion of the chamber 16, as viewed in FIG. 1.

An outlet passage 20 is also formed in the body member 12 and extends in a parallel, spaced relation to the leg portion 18a of the inlet passage 18 with the chamber 16 surrounding the lower portion of the passage 20. The passage 20 registers with an outlet opening 12b formed in the upper surface of body member 12 as viewed in FIG. 1.

It is understand that the inlet pipe 14 is connected to a source of fluid so that the fluid is introduced into the inlet opening 12a, and that the fluid may have particles, such a sediment, or the like, dispersed therein. It is also understood that a conduit, a pipe, or the like, is connected to the body member 12 in registry with the outlet opening 12b for receiving the fluid after it has passed through the body member device 10 in a manner to be described. As an example of the foregoing, the fluid is a gasoline and the device 10 is connected in the flow line for the gasoline between an underground storage tank and a dispensing station in a service station. In these applications, the gasoline often contains particles, such as sediment, etc. which must be separated from the gasoline before it is introduced into a vehicle.

A conical filter, or strainer, 24 extends in the chamber 16, and divides the chamber 16 into two radially-spaced substantially annular portions 16a and 16b. The strainer 24 is inverted as viewed in FIG. 1, with its larger-diameter end having an increased thickness to form a relatively rigid ring 24a which is also flexible enough to create a seal against the chamber 16 that engages that portion of the body member 12 defining the upper surface of the chamber 16. The smaller-diameter end of the strainer 24 is also enlarged to from a rigid ring 24b disposed at the end of that portion of the body member 12 defining the corresponding end of the outlet passage 20. Although not shown in the drawing, it is understood that a v-block seal is provided that is crushed to seal the strainer 24 to the corresponding portion of the body member 12.

Although not shown in the drawings, it is understood that the strainer 24 can also include a plurality of angularly-spaced, relatively rigid, struts extending between the rings 24a and 24b and preferably formed integrally therewith, to add structural integrity to the strainer. The remaining portion of the strainer 24 is formed of a mesh-like material which is designed to pass fluids but retain particles over a predetermined size. This material can vary according to the particular application in order to vary the size of the particles that can be captured. It also can be corrugated to add additional filtration surface area.

The ring 24b of the strainer 24 extends around a externally-threaded nipple 28 that extends in threaded engagement with that portion of the body member 12 defining the corresponding end portion of the outlet passage 20. Therefore, the location of the nipple 28 in the outlet passage 20 is axially adjustable by rotating the nipple.

A cover 30 extends over the lower end portion of the body member 12 defining the chamber 16 and the outlet passage 20. The cover 30 includes an outer dome portion 30a connected to an internal cylindrical portion 30b by a plurality of struts 30c. That portion of the cylindrical portion 30b defining its bore is threaded and is in threaded engagement with the corresponding end portion of the nipple 28 to secure the cover 30 to the body member 12, with the ring 24b of the strainer 24 captured between the cylindrical portion 30b and the corresponding face of the body member 12. A seal ring 32 extends in a notch formed in the face of the dome portion 30a of the cover 30 and engages the corresponding face of the body member 12 to seal against the escape of fluid from the body member.

In operation, pressurized fluid from the pipe 14 is introduced into the inlet opening 12a of the body member 12 and flows through the leg portions 18a and 18b of the passage 18 before entering the upper portion of the chamber portion 16a, as shown by the flow arrows in FIG. 1. The fluid then flows downwardly through the interior of the chamber 16 and generally radially across the strainer 24 into the chamber portion 16b. During this flow of the fluid through the strainer 24, any particles of a predetermined size that are dispersed in the fluid will be trapped on the interior surface of the strainer, thus separating these particles from the fluid. The purified fluid then exits the chamber portion 16b and passes into the cover 30 where it reverses its direction of flow, which reversal is facilitated by the dome shaped portion 30a of the cover. The separated fluid then enters the lower end of the outlet passage 20, passes upwardly through the length of the passage as viewed in FIG. 1, and exits the body member 12 via the outlet opening 20b.

The device and method of the present invention thus enjoy several advantages. For example, when the fluid flow through the device 10 is terminated, the separated particles in the strainer 24 cannot drop back into the passage 18, the inlet opening 12a, or the pipe 14. Also, the strainer 24 can easily be removed from the chamber 16 for cleaning or replacement by simply removing the cover 30 without the danger of spilling any separated particles that have accumulated therein. Further, the conical shaped portion of the strainer 24 provides a relatively large surface area for capturing the particles in the fluid as the latter flows through the strainer. Still further, the unique arrangement of the flow passages and the separating chamber and the resultant fluid flow reversals enable the device to be relatively compact and to be manufactured at a relatively low cost with a relatively short assembly time, utilizing a relatively low number of parts when compared to prior art designs.

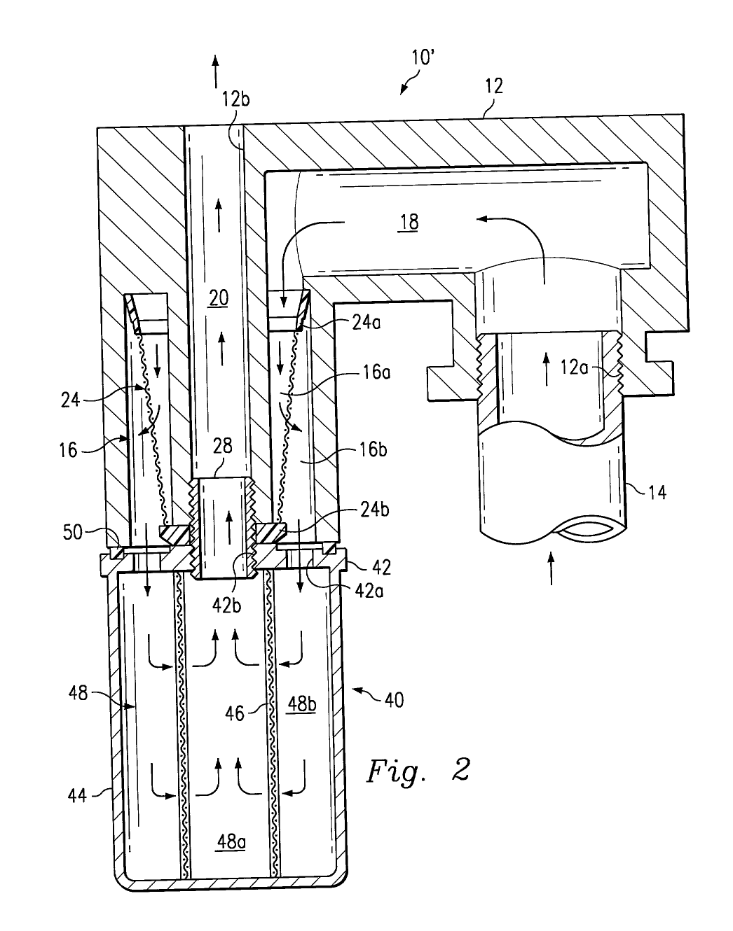

An alternative embodiment of the separating device is shown in general by the reference numeral 10′ in FIG. 2, and contains structure identical to that of the embodiment of FIG. 1 which is given the same reference numerals. According to the embodiment of FIG. 2, the cover 30 of the embodiment of FIG. 1 has been replaced by a filter unit 40 which reverses the direction of the fluid flow while providing redundant separation of the solid particles from the fluid. The filter unit 40 is formed by an end plate 42 and a body member 44 extending from the end plate to form an enclosure defining an internal chamber 48. A cylindrical strainer 46 is disposed in the chamber 48 and divides the chamber 48 into a central portion 48a and an annular portion 48b surrounding the central portion. The strainer 46 is formed of a mesh-like material which is designed to pass fluids but retain particles over a predetermined size, and which can vary according to the particular application in order to vary the size of the particles that can be captured.

An annular opening 42a is formed in the end plate 42 and registers with the chamber portion 16b, and the end plate has a threaded bore 42b for receiving the nipple 28 to secure the filter unit 40 to the body member 12, with the ring 24b of the strainer 24 being captured between the cylindrical end plate 42 and the corresponding face of the body member 12. A seal ring 50 extends in a notch formed in the face of the end plate 42 and engages the corresponding face of the body member 12 to seal against the escape of fluid from the body member.

In operation of the embodiment of FIG. 2, pressurized fluid from the pipe 14 is introduced into the inlet opening 12a of the body member 12 and flows through the legs 18a and 18b of the passage 18 before entering the upper portion of the chamber portion 16a, as shown by the flow arrows in FIG. 2. The fluid then flows downwardly through the interior of the chamber 16 and generally radially across the strainer 24 into the chamber portion 16b. During this flow of the fluid through the strainer 24, any particles of a predetermined size that are dispersed in the fluid will be trapped on the interior surface of the strainer, thus separating these particles from the fluid. The fluid then exits the chamber portion 16b and passes into the annular chamber 48b of the filter unit 40. The fluid then passes across the strainer 46 before reversing its direction of flow and passing upwardly, as viewed in FIG. 2, through the length of the central chamber 48b of the filter unit 40, as shown by the flow arrows. The fluid then flows upwardly into and through the passage 20 before exiting the body member 12 via the outlet opening 20b.

Thus, the embodiment of FIG. 2 enjoys all of the advantages of the embodiment of FIG. 1 yet provides for two-stage separation, with the filter unit 40 providing redundant filtering to insure that the fluid is relatively free of the solid particles. It is understood that the strainers 24 and 46 can be selected so that they both separate essentially the same sized particles or, alternately, strainer 24 can provide an initial separation of relatively coarse particles from the fluid, while the strainer 46 can provide separation of the relatively fine particles remaining in the fluid.

It is understood that variations may be made in the foregoing without departing from the scope of the present invention. For example, the specific arrangement and location of the inlet opening 12a and the outlet passage 20 can vary as long as the above objects, features and advantages of the device 10 are not compromised. Also the strainers of each of the previous embodiments can be replaced by any other type of separator, filter, or the like, as long as particles are separated from the fluid as the latter passes through the chamber.

It is understood that other modifications, changes and substitutions are intended in the foregoing disclosure and in some instances some features of the invention will be employed without a corresponding use of other features. Accordingly, it is appropriate that the appended claims be construed broadly and in a manner consistent with the scope of the invention.

What is claimed is:

1. A separating device for separating particles from fluid, the device comprising a body member defining an inlet passage for receiving the fluid, an outlet passage extending parallel to the inlet passage for discharging the fluid, a chamber connected to the inlet passage for receiving the fluid from the inlet passage, a separator disposed in the chamber for separating particles from the fluid as the fluid flows through the chamber, and a cover member connected to the chamber and the outlet passage for receiving the separated fluid, reversing the direction of the separated fluid and directing the separated fluid to the outlet passage for discharge from the body member.

2. The device of claim 1 wherein the inlet passage has a first leg portion extending from an inlet opening in the surface of the body member, and a second leg portion extending substantially perpendicular to the first leg portion and connecting the first leg portion to the chamber.

3. The device of claim 2 wherein the second leg portion of the inlet passage extends to one end of the chamber, and the fluid flows through the chamber in an opposite direction to its flow through the first leg portion.

4. The device of claim 1 wherein the axes of the chamber and the outlet passage extend in a coaxial relationship.

5. The device of claim 4 wherein the chamber is annular and surrounds the outlet passage.

6. The device of claim 5 wherein the cover member is a cover connected to the body member and adapted to receive the separated fluid from the chamber, reverse the direction of the fluid, and direct the fluid into the outlet passage.

7. The device of claim 6 wherein the cover has a dome portion to facilitate the reversing of the direction of flow of the fluid.

8. The device of claim 6 wherein the separator is a conical device formed of a mesh-like material which passes fluids and retains particles over a predetermined size.

9. The device of claim 5 wherein the cover member is a cylindrical housing adapted to receive the separated fluid from the chamber, reverse the direction of the fluid, and direct the fluid into the outlet passage.

10. The device of claim 9 further comprising a strainer disposed in the cylindrical housing and adapted to separate additional particles from the fluid.

11. The device of claim 10 wherein the latter strainer is cylindrical and divides the housing into a annular chamber for receiving the separated fluid from the first-mentioned chamber and a central chamber for receiving the separated fluid from the annular chamber and directing the fluid to the outlet passage, the latter strainer separating particles from the separated fluid as it passes from the annular passage into the central passage.

12. A method of separating particles from a fluid flowing through a conduit comprising the steps of flowing the fluid into an inlet passage, directing the fluid to flow from the inlet passage to a chamber, directing the fluid to flow though the chamber, separating the particles from the fluid as the fluid flows through the chamber, discharging the separated fluid from the chamber and reversing the direction of flow of the fluid, and then directing the fluid to flow to a discharge passage for discharging the fluid.

13. The method of claim 12 wherein the first step of directing comprises the step of reversing the direction of flow of the fluid.

14. The method of claim 13 wherein the fluid is directed in a first direction in the inlet passage and then in a second direction extending substantially perpendicular to the firsts direction.

15. The method of claim 14 wherein the fluid flows through the chamber in a direction opposite the first direction.

16. The method of claim 12 wherein the fluid is directed into one end of the chamber and is discharged from the other end thereof.

17. The method of claim 12 wherein the step of separating comprises the step of disposing a mesh-like material in the chamber which passes fluids and retains particles over a predetermined size.

18. The method of claim 12 wherein the first step of directing comprises the steps of directing the fluid through a vertical passage extending from an inlet opening in the surface of the body member, and a horizontal passage connecting the vertical leg to the chamber.
